(19) United States
(12) Patent Application Publication
(10) Pub. No.: US 2016/0077640 A1
(43) Pub. Date: Mar. 17, 2016

(54) DISPLAY APPARATUS INCORPORATING TOUCH SENSORS FORMED FROM LIGHT-BLOCKING MATERIALS

(71) Applicant: Pixtronix, Inc., San Diego, CA (US)

(72) Inventors: Patrick Forrest Brinkley, San Mateo, CA (US); Sriram Akella, San Jose, CA (US); Wilhelmus Adrianus De Groot, Palo Alto, CA (US)

(73) Assignee: PIXTRONIX, INC., San Diego, CA (US)

(21) Appl. No.: 14/488,694

(22) Filed: Sep. 17, 2014

(51) Int. Cl. G06F 3/047; G09G 5/00; G06F 3/044

(52) U.S. Cl. CPC G06F 3/047; G06F 3/044; G09G 5/003; G09G 2300/0426

(57) ABSTRACT

This disclosure provides systems, methods, and apparatus for incorporating a touch sensor into a display device. In one aspect, a display device can be formed from two opposing substrates coupled by an edge seal. An aperture plate can be fabricated on a rear surface of the front substrate. Apertures corresponding to display elements can be formed through the aperture plate. Conductive layers can be deposited over the rear surface of the front substrate and patterned to form portions of a capacitive touch sensor. The conductive layers also can be patterned to include apertures aligned with the apertures formed in the aperture plate. The apertures formed through the conductive layers may permit the conductive layers to be formed from light-blocking material without substantially impacting the optical quality of the display.

### TECHNICAL FIELD

This disclosure relates to the field of imaging displays, and to touch sensors incorporated into imaging displays.

### DESCRIPTION OF THE RELATED TECHNOLOGY

Electromechanical systems (EMS) devices include devices having electrical and mechanical elements, such as actuators, optical components (such as mirrors, shutters, and/or optical film layers) and electronics. EMS devices can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of deposited material layers, or that add layers to form electrical and electromechanical devices.

EMS-based display apparatus have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including a rear substrate, a front substrate positioned in front of the rear substrate, and a seal coupling the rear substrate and the front substrate. The apparatus includes a plurality of display elements positioned between the rear substrate and the front substrate. The apparatus includes an aperture layer positioned on a rear surface of the front substrate. The aperture layer includes a light-blocking material and can include a plurality of apertures each associated with a respective display element. The apparatus also includes a capacitive touch sensor. The capacitive touch sensor includes a first array of conductive elements positioned between the rear substrate and the rear surface of the front substrate. A first plurality of apertures is defined through these conductive elements and aligned with respective apertures defined through the aperture layer. The capacitive touch sensor also includes a second array of conductive elements positioned between the rear substrate and the rear surface of the front substrate. A second plurality of apertures is defined through these conductive elements and aligned with respective apertures defined through the aperture layer.

In some implementations, the first and second arrays of conductive elements can include light-blocking materials. In some implementations, the aperture layer can include an electrically insulating material. In some implementations, the apparatus also can include a conductive shield layer positioned between the capacitive touch sensor and the plurality of display elements.

In some implementations, each conductive element of the first and second arrays of conductive elements can have a resistance of less than about 100 ohms. In some implementations, each conductive element of the first and second arrays of conductive elements can have a surface area in the range of about 1 millimeter to about 50 millimeters. In some implementations, the distance between each conductive element of the first and second arrays of conductive elements is in the range of about 1 millimeter to about 50 millimeters.

In some implementations, both the first array of conductive elements and the second array of conductive elements can be positioned behind the aperture layer with respect to the front of the apparatus. In some implementations, both the first array of conductive elements and the second array of conductive elements can include a reflective metal. In some implementations, the second array of conductive elements can be positioned in front of the aperture layer with respect to the front of the apparatus. In some implementations, the second array of conductive elements can include a light-absorbing metal.

In some implementations, the first array of conductive elements also can be positioned in front of the aperture layer with respect to the front of the apparatus. In some implementations the first and second array of conductive elements can include a light-absorbing metal. In some implementations, the second array of conductive elements can be positioned in front of the aperture layer and the first array of conductive elements can be positioned behind the aperture layer with respect to the front of the apparatus with respect to the front of the apparatus.

In some implementations, the apparatus can be included in a display. The apparatus also can include a processor that is capable of communicating with the display. The processor can be capable of processing image data. The apparatus also can include a memory device that is capable of communicating with the processor.

In some implementations, the apparatus also can include a driver circuit capable of sending at least one signal to the display and a controller capable of sending at least a portion of the image data to the driver circuit. In some implementations, the apparatus also can include an image source module capable of sending the image data to the processor. The image source module can include a receiver, a transceiver, and/or a transmitter. In some implementations, the apparatus also can include an input device capable of receiving input data and communicating the input data to the processor.

Another innovative aspect of the subject matter described in this disclosure can be implemented in a method of forming a display device. The method includes depositing a substantially light-blocking material on a rear surface of a first substrate. The method includes patterning the substantially light-blocking material to define a plurality of apertures. The method includes depositing a first conductive material over the rear surface of the first substrate. The method includes patterning the first layer of conductive material to define a first array of conductive elements forming a first portion of a capacitive touch sensor and a plurality of apertures associated with respective apertures formed through the substantially light-blocking material. The method includes depositing a second conductive material over the rear surface of the first substrate. The method includes patterning the second layer of conductive material to define a second array of conductive elements forming a second portion of the capacitive touch sensor and a plurality of apertures associated with respective apertures formed in the substantially light-blocking material. The method includes positioning a second substrate such that the second substrate is substantially parallel to the first substrate and a front surface of the second substrate opposes the rear surface of the first substrate. The method includes forming an edge seal around the perimeters of the first and second substrates to couple the first and second substrates to one another. The method also includes filling a gap between the first and second substrates with a fluid such that the fluid substantially surrounds a plurality of display elements formed on one of the first and second substrates.

In some implementations, the first conductive material can include a substantially light-absorbing metal. In some implementations, the light-blocking material can be deposited between the first conductive material and the second conductive material. In some implementations, the second conductive material can include a substantially light-reflecting metal.

In some implementations, the method can include fabricating the plurality of display elements on the rear surface of the first substrate. In some implementations, the method can include fabricating the plurality of display elements on the front surface of the second substrate. In some implementations, the method can include depositing a layer of insulating material over the first array of conductive elements.

Another innovative aspect of the subject matter described in this disclosure can be implemented in an apparatus including a rear substrate, a front substrate positioned in front of the rear substrate, and a seal coupling the rear substrate and the front substrate. The apparatus includes a plurality of display elements positioned between the rear substrate and the front substrate. The apparatus includes a rear aperture layer positioned on a front surface of the rear substrate. The rear aperture layer includes a light-blocking material and includes a plurality of rear apertures each associated with a respective display element. The apparatus includes a front aperture layer positioned on a rear surface of the front substrate. The front aperture layer includes an electrically insulating, light-blocking material and includes a plurality of front apertures each associated with a respective display element. The apparatus also includes a capacitive touch sensor. The capacitive touch sensor includes a first array of conductive elements positioned between the rear substrate and the rear surface of the front substrate. A first plurality of apertures is defined through these conductive elements and aligned with respective apertures defined through the front aperture layer. The capacitive touch sensor also includes a second array of conductive elements positioned between the rear substrate and the rear surface of the front substrate. A second plurality of apertures is defined through these conductive elements and aligned with respective apertures defined through the front aperture layer. The capacitive touch sensor also includes a controller coupled to the first array of conductive elements and the second array of conductive elements. The controller is configured to periodically measure a capacitance between a first conductive element of the first array of conductive elements and a second conductive element of the array of second conductive elements. The controller is configured to determine a presence and location of a conductive touch input device, based on the measured capacitance. The apparatus also includes a conductive shield layer deposited between the capacitive touch sensor and the plurality of display elements.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a cross sectional view of an example display apparatus incorporating shutter-based light modulators.

FIG. 4A illustrates a top view of an example capacitive touch sensor that can be integrated into a display apparatus.

FIG. 4B shows an enlarged view of a portion of the example capacitive touch sensor shown in FIG. 4A.

FIG. 4C shows an example front aperture layer that can be positioned behind or in front of the example capacitive touch sensor shown in FIG. 4B.

FIG. 5A shows a first cross-sectional view along the line A-A′ of a first example display device incorporating a first example implementation of the touch sensor shown in FIGS. 4A and 4B.

FIG. 5B shows a second cross-sectional view along the line B-B′ of the first example display device shown in FIGS. 4A and 4B.

FIG. 5C shows a cross-sectional view along the line A-A′ of a second example display device incorporating a second example implementation of the touch sensor shown in FIGS. 4A and 4B.

FIG. 5D shows a cross-sectional view along the line A-A′ of a third example display device incorporating a third example implementation of the touch sensor shown in FIGS. 4A and 4B.

FIG. 6 shows a flow diagram of an example process for manufacturing a display apparatus.

FIGS. 7A-7F show cross-sectional views of stages of construction of an example display according to the manufacturing process shown in FIG. 6.

FIGS. 8A and 8B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

MEMS displays can incorporate shutter-based display elements positioned between two substrates. The substrates can be joined by a seal formed around the perimeters of the substrates. Some touch sensors for displays are formed from transparent conductive layers that are laminated to a separate substrate bonded to the front of the display, which adds thickness to the overall display assembly. A touch sensor can be integrated into a display more efficiently by being fabricated on a rear surface of a front substrate. An aperture layer can be fabricated on the front substrate. The aperture layer can be formed from a light-absorbing material that absorbs ambient light and off-angle light propagating through the display. The touch sensor can be formed from one or more conductive layers that are patterned to include apertures aligned with display elements and apertures formed in the aperture layer.

Light-blocking materials used to form the conductive layers of the touch sensor can include light-absorbing materials or light-reflecting materials. In some implementations, conductive layers of the touch sensor that are deposited on the front side of the aperture layer may be formed from light-absorbing materials to absorb ambient light. Conductive layers deposited behind the aperture layer may be formed from either light-absorbing or light-reflecting materials. In some other implementations, the conductive layers of the touch sensor can be formed from transparent materials.

Particular implementations of the subject matter described in this disclosure can be implemented to realize one or more of the following potential advantages. By fabricating a touch sensor directly on the aperture plate, the display can be thinner because the need to laminate a separate touch sensor above the front substrate of the display is eliminated. Apertures can be formed in the touch sensor conductive layers so that the conductive layers may be formed from light-blocking materials while still allowing light from display elements to pass through the display. Light-blocking conductive materials are typically cheaper than transparent conductors, which can reduce the overall cost of manufacturing a display. Light-blocking conductors also typically have lower electrical resistances than transparent conductors. As a result, the touch sensor can be operated with less power than a touch sensor formed from transparent conductive material.

The use of light-blocking conductors in a touch sensor also can improve image quality. Common transparent conductors, such as ITO, have a high refractive index (such as around 1.8) and poor blue color transmission (such as around 80%), which can reduce light transmission, resulting in decreased optical performance. Transparent conductors also may cause undesirable image artifacts to appear in the display, for example due to differing light transmission rates of different wavelengths. By avoiding the use transparent conductors, the transmission loss from the transparent conductors is reduced, thereby further decreasing the power consumption and improving the color saturation of the display. The aforementioned image artifacts also may be avoided.

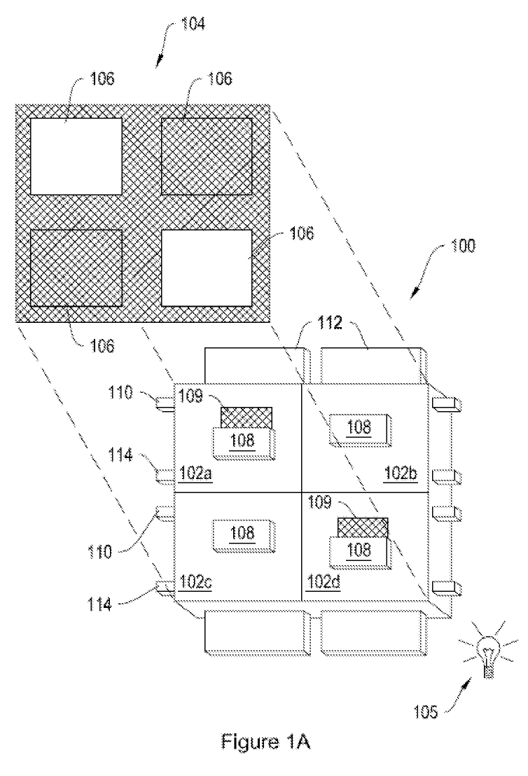

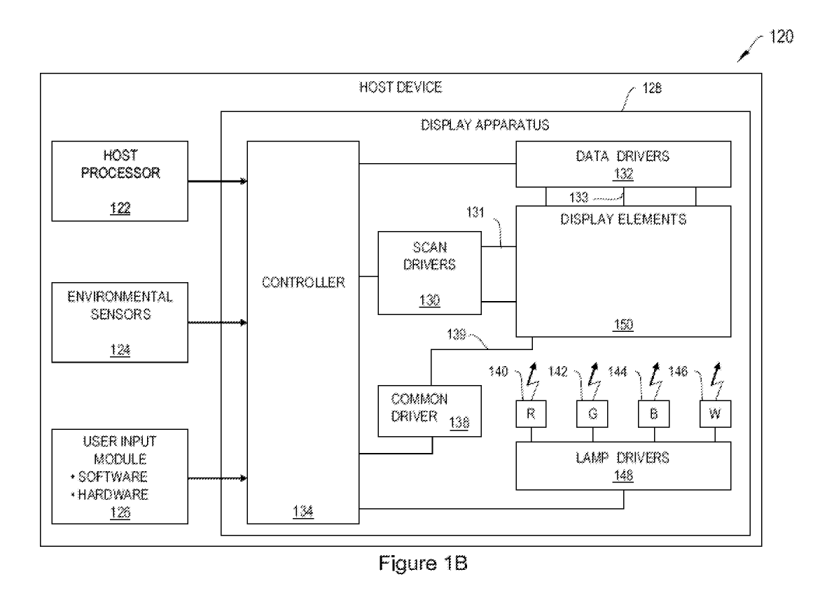

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

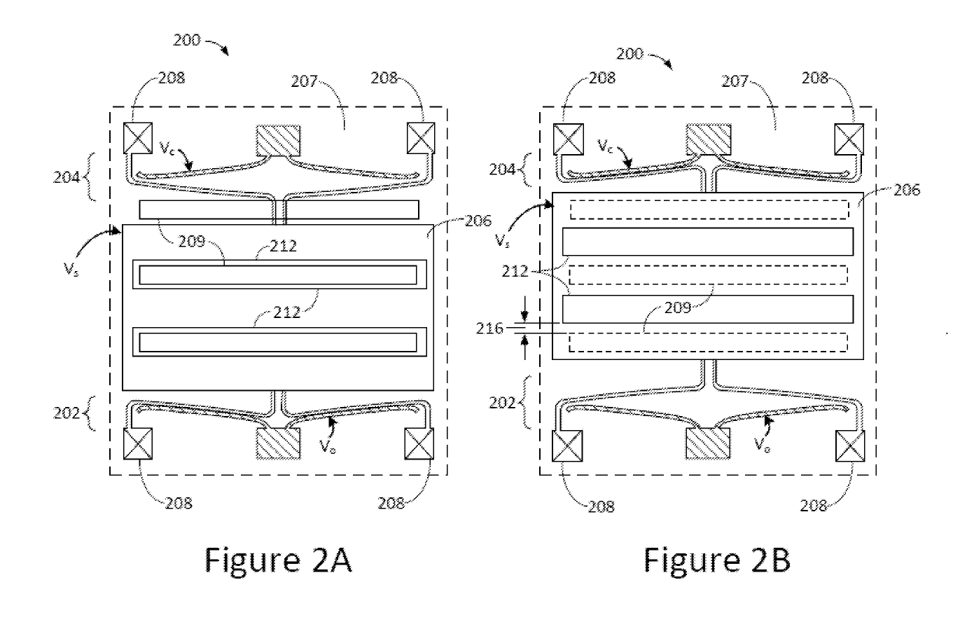

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

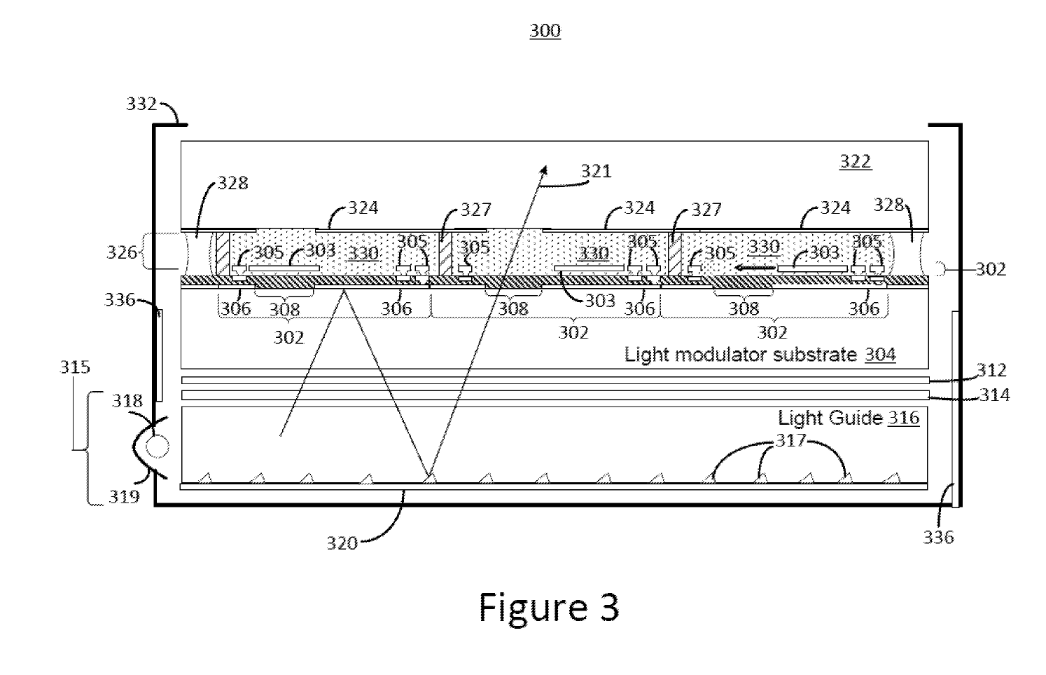

FIG. 3 shows a cross sectional view of an example display apparatus 300 incorporating shutter-based light modulators. As shown, the shutter-based light modulators take the form of shutter assemblies 302, similar to the shutter assemblies 200 shown in FIGS. 2A and 2B. Each shutter assembly 302 incorporates a shutter 303 and anchors 305. Not shown are the compliant beam electrode actuators which, when connected between the anchors 305 and the shutters 303, help to suspend the shutters 303 a short distance above the surface. The shutter assemblies 302 are disposed on a transparent rear substrate 304, such as a substrate made of plastic or glass. A rear-facing reflective layer, reflective film 306, disposed on the rear substrate 304 defines a plurality of apertures 308 located beneath the closed positions of the shutters 303 of the shutter assemblies 302. The reflective film 306 reflects light not passing through the apertures 308 back towards the rear of the display apparatus 300.

The display apparatus 300 includes an optional diffuser 312 and/or an optional brightness enhancing film 314 which separate the rear substrate 304 from a planar light guide 316. The light guide 316 includes a transparent material, such as glass or plastic. The light guide 316 is illuminated by one or more light sources 318. The light guide 316, together with the light sources 318 form a backlight. The light sources 318 can be, for example, and without limitation, incandescent lamps, fluorescent lamps, lasers or LEDs. A reflector 319 helps direct light from the light sources 318 towards the light guide 316. A front-facing reflective film 320 is disposed behind the light guide 316, reflecting light towards the shutter assemblies 302.

The light guide 316 includes a set of geometric light redirectors or prisms 317 which re-direct light from the light sources 318 towards the apertures 308 and hence toward the front of the display 300. The light redirectors 317 can be molded into the plastic body of light guide 316 with shapes that can be alternately triangular, trapezoidal, or curved in cross section. The density of the prisms 317 generally increases with distance from the light source 318.

A front substrate 322 forms the front of the display apparatus 300. The rear side of the front substrate 322 can be covered with a patterned light blocking layer 324 to increase contrast. The front substrate 322 is supported a predetermined distance away from the shutter assemblies 302 forming a cell gap 326. The cell gap 326 is maintained by mechanical supports or spacers 327 and/or by an adhesive seal 328 attaching the front substrate 322 to the rear substrate 304.

The adhesive seal 328 seals in a fluid 330. The fluid 330 can have a low coefficient of friction, low viscosity, and minimal degradation effects over the long term. The fluid immerses and surrounds the moving parts of the shutter assemblies 302, and can serve as a lubricant. In some implementations, the fluid 330 is a hydrophobic liquid with a low surface wetting capability. In some implementations, the fluid 330 has a refractive index that is either greater than or less than that of the rear substrate 304. In some implementations, in order to reduce the actuation voltages, the fluid 330 has a viscosity below about 70 centipoise. In some other implementations, the liquid has a viscosity below about 10 centipoise. Liquids with viscosities below 70 centipoise can include materials with low molecular weights: below 4000 grams/mole, or in some cases below 400 grams/mole. Fluids that may be suitable as the fluid 330 include, without limitation, de-ionized water, methanol, ethanol and other alcohols, paraffins, olefins, ethers, silicone oils, fluorinated silicone oils, or other natural or synthetic solvents or lubricants. Useful fluids also can include polydimethylsiloxanes (PDMS), such as hexamethyldisiloxane and octamethyltrisiloxane, or alkyl methyl siloxanes such as hexylpentamethyldisiloxane. Additional useful fluids include alkanes, such as octane or decane, nitroalkanes, such as nitromethane, and aromatic compounds, such as toluene or diethylbenzene. Further useful fluids include ketones, such as butanone or methyl isobutyl ketone, chlorocarbons, such as chlorobenzene, and chlorofluorocarbons, such as dichlorofluoroethane or chlorotrifluoroethylene. Other suitable fluids include butyl acetate, dimethylformamide, hydro fluoro ethers, perfluoropolyethers, hydro fluoro poly ethers, pentanol, and butanol. Example suitable hydro fluoro ethers include ethyl nonafluorobutyl ether and 2-trifluoromethyl-3-ethoxydodecafluorohexane.

A sheet metal or molded plastic assembly bracket 332 holds the front substrate 322, the rear substrate 304, the backlight and the other component parts of the display apparatus 300 together around the edges. The assembly bracket 332 is fastened with screws or indent tabs to add rigidity to the combined display apparatus 300. In some implementations, the light source 318 is molded in place by an epoxy 7 potting compound. Reflectors 336 help return light escaping from the edges of the light guide 316 back into the light guide 316. Not depicted in FIG. 3 are electrical interconnects which provide control signals as well as power to the shutter assemblies 302 and the lamps 318.

The display apparatus 300 is referred to as having a MEMS-up configuration, in which the MEMS based light modulators are formed on a front surface of the rear substrate 304, i.e., the surface that faces toward the viewer. In an alternate implementation, referred to as the MEMS-down configuration, the shutter assemblies are disposed on a substrate separate from a substrate on which a reflective aperture layer is formed. The substrate in the MEMS-down configuration on which the aperture layer is formed, defining a plurality of apertures, is referred to as the aperture plate. In the MEMS-down configuration, the substrate that carries the MEMS-based light modulators takes the place of the front substrate 322 in the display apparatus 300 and is oriented such that the MEMS-based light modulators are positioned on the rear surface of this front substrate, i.e., the surface that faces toward the light guide 316.

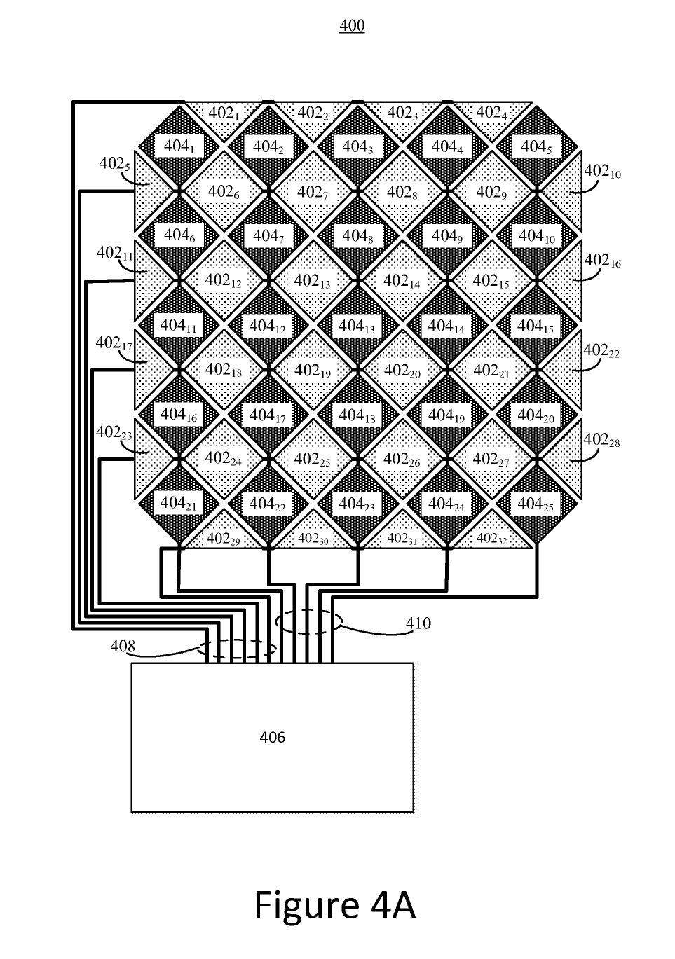

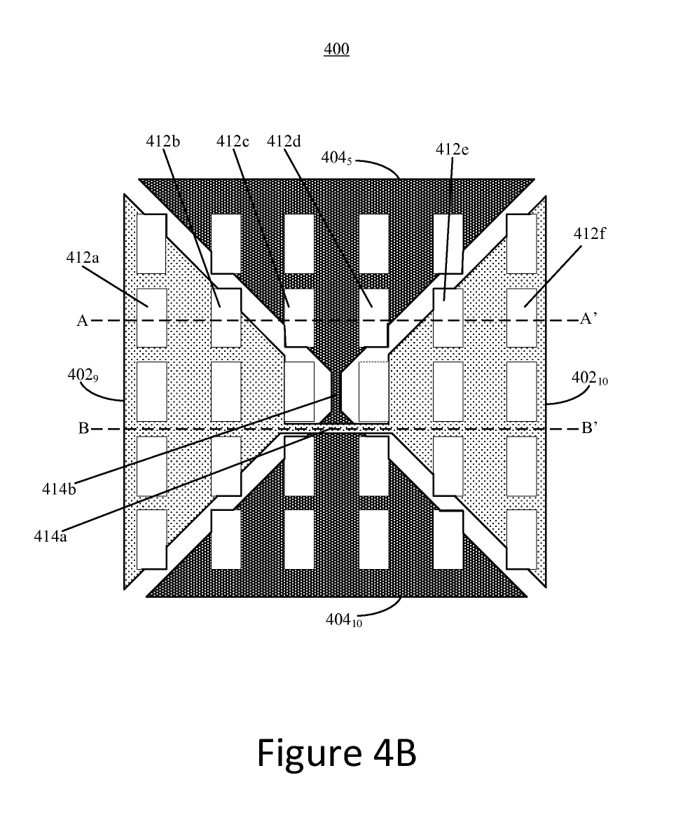

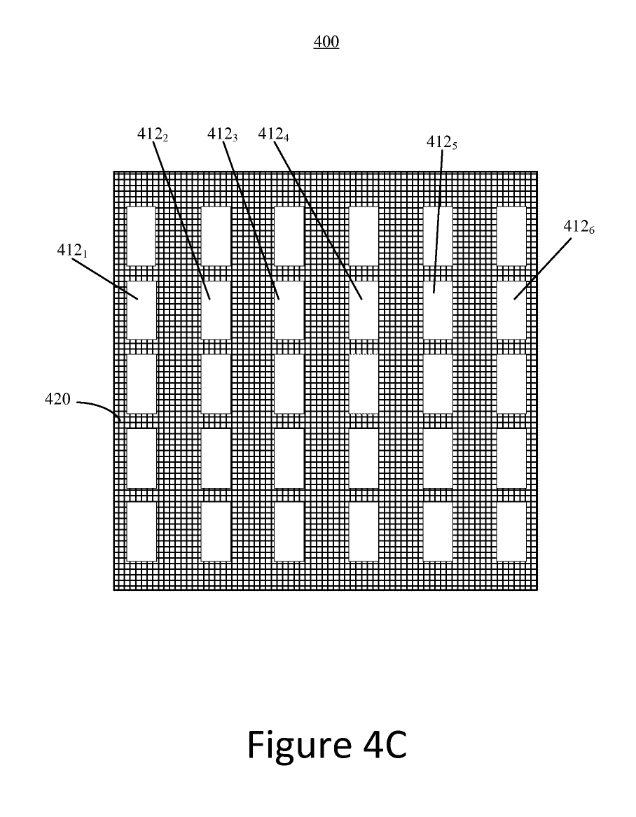

FIG. 4A illustrates a top view of an example capacitive touch sensor 400 that can be integrated into a display apparatus. The touch sensor 400 includes a first array of diamond-shaped conductors 402₁-402₃₂ (generally referred to as first conductors 402) and a second array of diamond-shaped conductors 404₁-404₂₅ (generally referred to as second conductors 404). The first conductors 402 and second conductors 404 are arranged in a grid pattern within the touch sensor 400 such that each first conductor 402 (other than the first conductors 402 around the perimeter of the touch sensor 400) is surrounded by four neighboring second conductors 404, and likewise each second conductor 404 (other than the second conductors 404 around the perimeter of the touch sensor 400) is surrounded by four neighboring first conductors 402. While the touch sensor 400 is shown as having 32 first conductors 402 and 25 second conductors 404, it should be noted that any number of first conductors 402 and second conductors 404 may be included in the touch sensor 400 in other implementations. In addition, the first and second conductors may have other shapes and arrangements without departing from the scope of the disclosure. For example, the conductors could be rectangular, circular, triangular, or other shaped designs, or portions thereof such polygons. Additionally, in some implementations, the touch sensor 400 might be void of conductive surfaces, such as in a wire frame-only implementation. In such an example, the diamond pattern of 404 and 402 would be a narrow wire frame around each diamond perimeter without a conductive surface in the diamond interior.

The first conductors 402 are arranged in rows and are electrically connected such that each first conductor 402 is electrically connected to the adjacent first conductors 402 in its respective row. The second conductors 404 are arranged in columns and are electrically connected such that each second conductor 404 is electrically connected to the adjacent second conductors 404 in its respective column. The term “row” is used throughout this disclosure to refer to conductors that are adjacent to one another along the horizontal direction as shown in FIG. 4A, while the term “column” is used to refer to conductors that are adjacent to one another along the vertical direction as shown in FIG. 4A. However, one of skill in the art will readily understand that the terms “row” and “column” may be interchanged without departing from the scope of the disclosure. A controller 406 is coupled to each row of first conductors 402 by electrical connections 408 and to each column of second conductors 404 by electrical connections 410.

Each of the first conductors 402 and the second conductors 404 is formed from an electrically conductive material. The touch sensor 400 can be used to determine a position of an electrically conductive object, such as a human finger, or other body part, a stylus, or other conducting pointing device that comes into close proximity with the touch sensor 400. For example, in some implementations, the controller 406 may determine the presence and position of a human finger by monitoring the capacitance between each first conductor 402 and each respective neighboring second conductor 404. When a human touches the touch sensor 400 with a finger, stylus or other pointing device, the electric field local to the touch location is altered, and as a result the capacitance between a first conductor 402 and a neighboring second conductor 404 in the vicinity of the touch will change. Therefore, by monitoring the capacitance between each first conductor 402 and neighboring second conductors 404, the controller 406 can determine whether a touch has occurred, as well as the position of the touch (i.e., the row as indicated by the first conductor 402 and column as indicated by the second conductor 404) within the touch sensor 400.

In some implementations, the capacitance may be monitored periodically. The duration of the period used for measuring the capacitance between each first conductor 402 and neighboring second conductor 404 may be varied. For example, when a touch is detected, the period may be decreased so that a touch gesture formed by a user of the device may be more accurately detected. On the other hand, when no touch is detected, the period for measuring the capacitance may be increased to conserve power. In some implementations, capacitance measurements of the touch sensor 400 can be synchronized with the refresh cycle of the display into which the touch sensor 400 is incorporated. Electrical signals used to refresh the display elements of the display can alter the capacitance measurement between the first conductors 402 and second conductors 404, thereby interfering with accurate measurement of capacitance changes caused by a finger or stylus. Therefore, measuring the capacitance of the first conductors 402 and second conductors 404 at a time when the display is not refreshing can result in more accurate detection of touch input. Accordingly, in some implementations, the period used to measure capacitances of the first conductors 402 and second conductors 404 may be synchronized with and offset from the refresh period of the display, to ensure that capacitance measurements are not made when the display is refreshing.

In some other implementations, rather than measuring a capacitance between a first conductor 402 and an adjacent second conductor 404, the self-capacitance of each first conductor 402 or second conductor 404 may be measured instead. In some such implementations, each first conductor 402 and each second conductor 404 include an individual electrical connection to the controller 406. The controller 406 can then periodically measure the self-capacitance of each first conductor 402 and each second conductor 404, and can determine that a change in the self-capacitance of one of the conductors indicates a touch input from the user. In some implementations, a single conductor layer may be used to create the touch sensor.

In some implementations, a user's finger may simultaneously contact many adjacent first conductors 402 and second conductors 404. Accordingly, in some implementations, a capacitance change map for the first conductors 402 and the second conductors 404 can be generated, and a centroid of the capacitance change map may be calculated. The position of the touch may be determined to be at the calculated centroid. In this way the positional accuracy of the touch location may be finer than the first and second conductor spacing. In some implementations, the controller 406 can be capable of detecting multiple simultaneous touches.

The touch sensor 400 can be incorporated into an electronic device to receive touch input from a user. In some implementations, each first conductor 402 and each second conductor 404 may have a size selected to be approximately equal to the surface area typically covered by a human finger, a stylus, or another conductive pointing device when a user provides a touch input to an electronic device. For example, the first conductors 402 and second conductors 404 may each have a surface area in the range of about 1 square millimeters to about 50 square millimeters. In some implementations, the distance between adjacent first conductors 402 and second conductors 404 may be in the range of about 1 millimeter to about 50 millimeters. In some implementations, the first conductors 402 and second conductors 404 may be formed from light-blocking, electrically conductive materials such as aluminum (Al), molybdenum (Mo), or tantalum (Ta). In some other implementations, the first conductors 402 and second conductors 404 may be formed from transparent conductors, such as indium tin oxide (ITO).

The touch sensor 400 may be integrated into a device having an electronic display, such as the display device 300 shown in FIG. 3. In implementations in which the touch sensor 400 is integrated with the display to allow a user to enter touch input directly on the display, each first conductor 402 and second conductor 404 can include at least one aperture corresponding to a display element of the display, so that the touch sensor 400 does not substantially interfere with the light output of the display. Examples of first conductors 402 and second conductors 404 having such apertures are described further below in connection with FIGS. 4B and 4C.

FIG. 4B shows an enlarged view of a portion of the example capacitive touch sensor 400 shown in FIG. 4A. For illustrative purposes, only a portion of the touch sensor 400 is shown in FIG. 4. Specifically, a portion of the first conductors 402₉ and 402₁₀, and a portion of the second conductors 404₅ and 404₁₀ are shown. The first conductors 402 and second conductors 404 include a plurality of apertures illustrated as rectangles, such as the apertures 412a-412f. The apertures 412a-412f are generally referred to as apertures 412. The apertures 412 can be arranged in a grid pattern. Each aperture 412 can correspond to a display element forming an image pixel. In some implementations, multiple apertures 412 may correspond to a single display element. In some other implementations, the first conductors 402₉ and 402₁₀ can be formed from a light-absorbing material.

The first conductors 402₉ and 402₁₀, are coupled by an electrical connection 414a and the second conductors 404₅ and 404₁₀ are coupled by an electrical connection 414b (generally referred to as electrical connections 414). The first conductors 402, second conductors 404, and electrical connections 414 are arranged so as not to interfere with the positioning of the apertures 412. For example, the electrical connection 414a is located between rows of the apertures 412, and the electrical connection 414b is located between columns of the apertures 412, so that the electrical connections 414 do not overlap with any of the apertures 412, which could obstruct light passing through the apertures 412.

As discussed above, the first conductors 402 and second conductors 404 may each have a surface area in the range of about one square millimeter to about 50 square millimeters. In many electronic devices, the density of display elements will therefore be significantly higher than the density of first conductors 402 and second conductors 404. For example, in some implementations, each of the first conductors 402 and second conductors 404 may include more than one thousand apertures 412 corresponding to display elements. The arrangement of apertures 412 shown in FIG. 4B is illustrative only. In some other implementations, any suitable arrangement may be used.

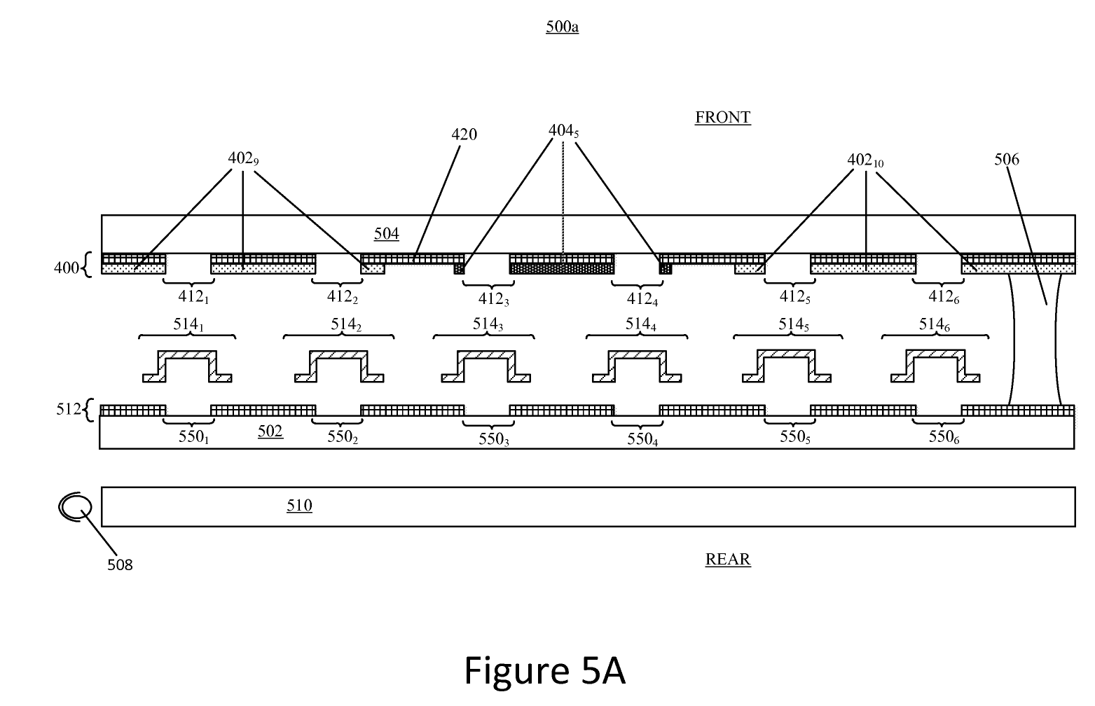

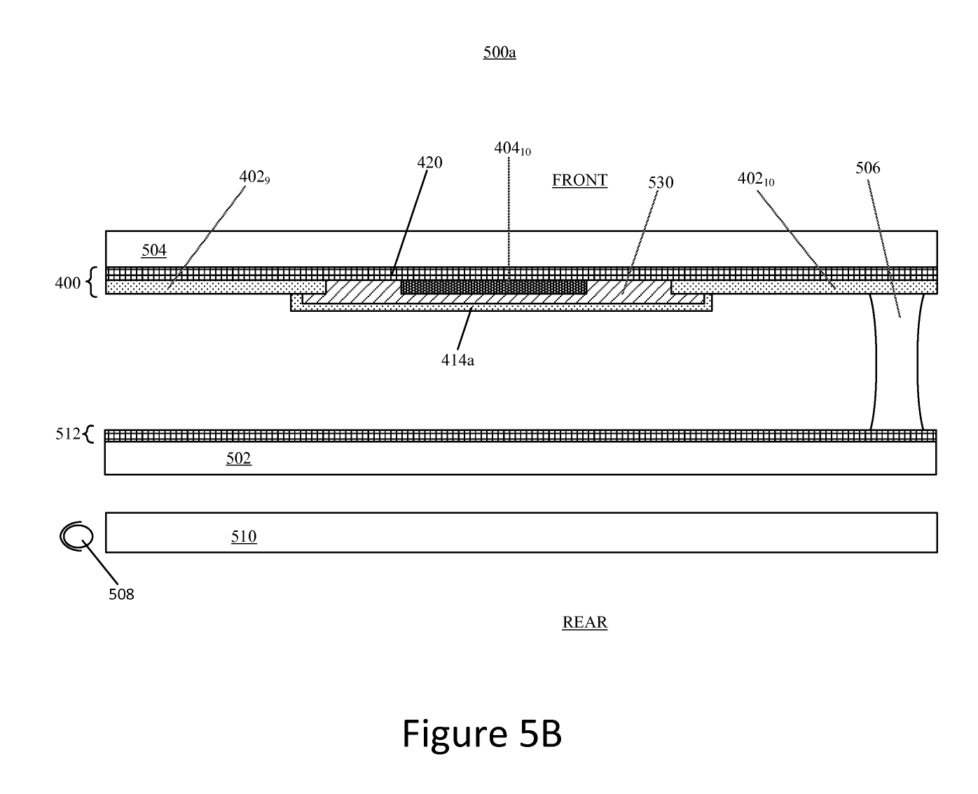

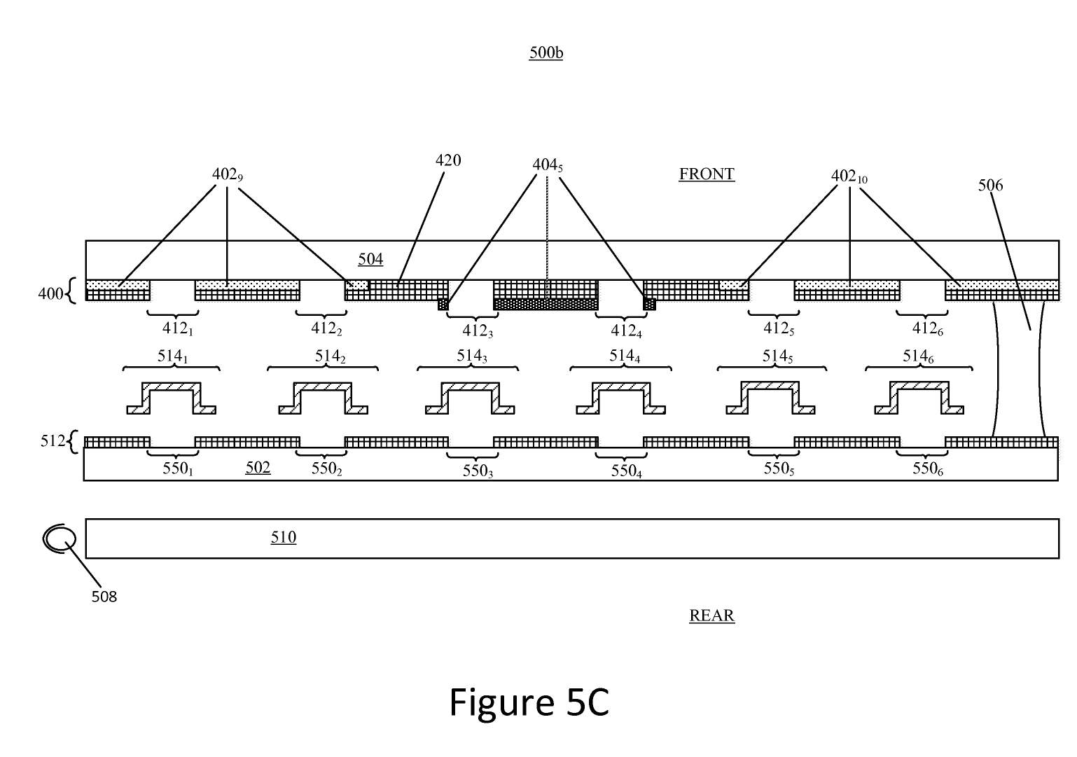

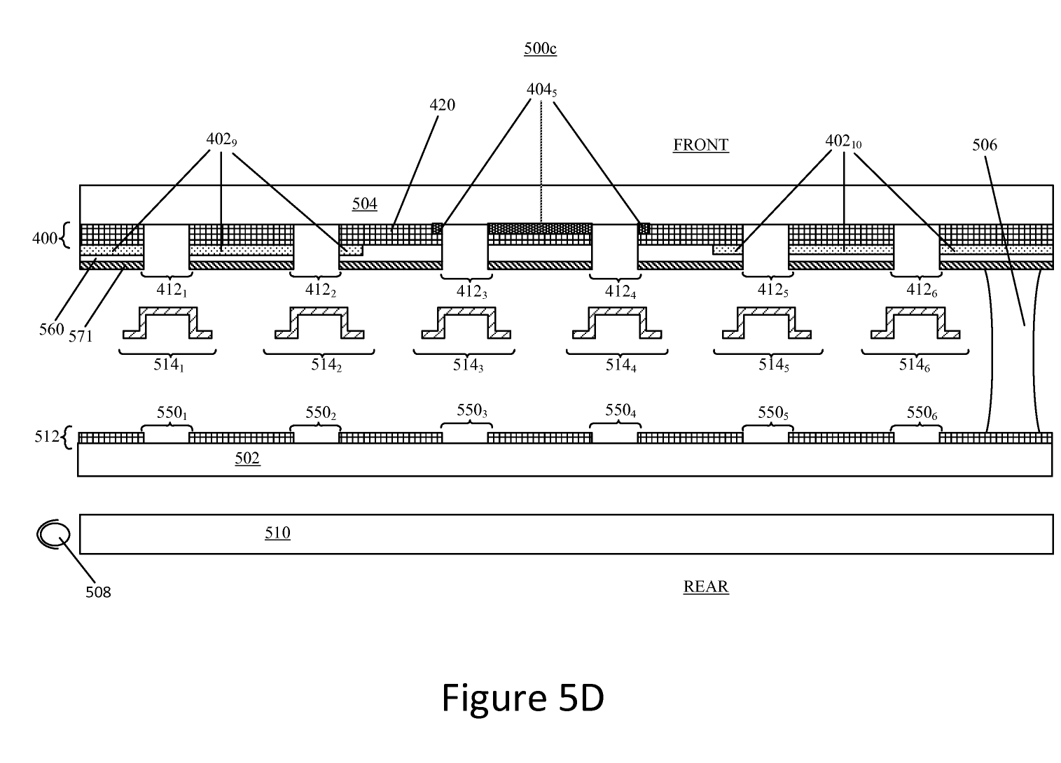

FIG. 4C shows an example front aperture layer 420 that can be positioned behind, in front of, or between layers of the example capacitive touch sensor 400 shown in FIG. 4A. The portion of the front aperture layer 420 shown in FIG. 4C corresponds to the portion that would be directly aligned with the portion of the capacitive touch sensor 400 shown in FIG. 4B. The apertures 412 formed through the capacitive touch sensor 400 also extend through the front aperture layer 420. Thus, light may pass through both the touch sensor 400 and the front aperture layer 420 via the apertures 412. In some implementations, the front aperture layer 420 may be adjacent to, and in contact with one or both of the first electrodes 402 and the second electrodes 404 that form the touch sensor 400. In some other implementations, there may be intervening layers, as described further below in connection with FIG. 5B and FIG. 5C.

The front aperture layer 420 can be formed from a light-absorbing material to absorb light originating within the display (i.e., behind the front aperture layer 420) that is not directed through the apertures 412, as well as to absorb ambient light originating outside the display (i.e., in front of the front aperture layer 420). For example, the front aperture layer 420 can be formed from a light-absorbing cermet material, which can include composites of small metal particles in an oxide or nitride matrix.

In some implementations, the front aperture layer 420 is formed from an electrically insulating material. In some implementations, the electrically insulating front aperture layer 420 can be positioned between the first conductors 402₉ and 402₁₀ and the second conductors 404₅ and 404₁₀. That is, the first conductors 402₉ and 402₁₀ can be positioned substantially within a first plane and the second conductors 404₅ and 404₁₀ can be positioned substantially within a second plane, parallel to the first plane. The front aperture layer 420 can then be positioned substantially within a third plane between the first and second planes, so that the first conductors 402₉ and 402₁₀ are separated from the second conductors 404₅ and 404₁₀ by the front aperture layer 420. This can help to electrically isolate the first conductors 402₉ and 402₁₀ from the second conductors 404₅ and 404₁₀, which can be helpful for the touch sensor 400 to function properly. For example, the front aperture layer 420 can be formed from a dielectric material.

FIG. 5A shows a cross-sectional view along the line A-A′ of a first example display device 500a incorporating a first example implementation of the enlarged view of the touch sensor 400 shown in FIGS. 4A and 4B. The device 500a includes many of the features of the display device 300 shown in FIG. 3. For example, the display device 500a includes a rear substrate 502 coupled to a front substrate 504 by an edge seal 506. In some implementations, a light source 508 and a light guide 510 together form a backlight. A rear aperture layer 512 defines a plurality of apertures 550₁-550₆ (generally referred to as apertures 550), each associated with a respective shutter-based display element 514₁-514₆ (generally referred to as display elements 514). The shutters of the display elements 514 are shown in the closed position, obstructing the light path from the apertures 550 in the rear aperture layer 512 to the apertures 412 in the front aperture layer 420.

The first conductors 402₉ and 402₁₀ and the second conductor 404₅ are positioned behind the front aperture layer 420. Because they are positioned behind the front aperture layer 420, the first conductors 402₉ and 402₁₀ and the second conductor 404₅ can be formed from either light-absorbing material or light-reflecting material. In some implementations, the first conductors 402₉ and 402₁₀ can be made from a light-absorbing, conductive material, such as a dark metal. For example, the first conductors 402₉ and 402₁₀ can be formed from molybdenum chromium (MoCr), molybdenum tungsten (MoW), molybdenum titanium (MoTi), molybdenum tantalum (MoTa), titanium tungsten (TiW), and titanium chromide (TiCr). The above alloys or simple metals, such as nickel (Ni) and chromium (Cr) with rough surfaces also can be effective at absorbing light. In some other implementations, the first conductors 402₉ and 402₁₀ and the second conductor 404₅ can be formed from a light-reflecting material, such as aluminum or tantalum. Light reflected by the first conductors 402₉ and 402₁₀ and the second conductor 404₅ can be absorbed by the rear aperture layer 420 without escaping from the display.

In addition to the optical benefits discussed above, other advantages also can be realized by forming the first conductors 402 and the second conductors 404 from metals or other opaque conductive materials. For example, such materials can have a significantly lower cost than transparent conductive materials, and as a result, the overall cost to manufacture the display 500a can be lower than the cost to manufacture a similar display that uses transparent materials for a touch sensor. Furthermore, opaque conductive materials typically have lower resistances and higher conductivities than transparent conductive materials, and can therefore be operated using less electrical power than devices that use transparent conductive materials. In some implementations, the resistance of the materials used to form the first conductors 402 and the second conductors 404 is less than about one ohm (Ω). The touch sensor 400 can therefore allow the display 500a to consume less power than a display that incorporates a touch sensor formed from a transparent conductive material. In some implementations, the resistance of each row of first conductors 402 may be greater than the resistance of the individual first conductors 402. For example, due to the narrow width of the interconnects joining adjacent first conductors 402, the total electrical resistance of a row of first conductors 402 may be in the range of about 1 ohm to about 100 ohms. In some other implementations, the total electrical resistance of a row of first conductors 402 may be greater, for example in the range of about 100 ohms to about 1000 ohms, without departing from the scope of the disclosure. Generally, the resistance of each row of first conductors 402 may be significantly lower (e.g., one to two orders of magnitude lower) than the resistance of a transparent conductor having similar dimensions. The same electrical characteristics also may apply to each column of second conductors 404.

FIG. 5B shows a second cross-sectional view along the line B-B′ of the first example display device 500a shown in FIGS. 4A and 4B. In the example shown in FIG. 5B, the first conductors 402₉ and 402₁₀ and the second conductor 404₁₀ are formed in a single layer behind the front aperture layer 420. The electrical connection 414a is provided to achieve electrical continuity between the first conductors 402₉ and 402₁₀. In some implementations, the electrical connection 414a is formed from the same material used to form the first conductors 402₉ and 402₁₀. Insulating material 530 is provided to isolate the second conductor 404₁₀ from the first conductors 402₉ and 402₁₀ and the electrical connection 414a. In some other implementations, the electrical connection 414a may be formed in a different way. For example, the first conductors 402₉ and 402₁₀ and the second conductor 404₁₀ may be formed in different layers, as shown in the cross-sectional views of FIGS. 5B and 5C and described further below. The electrical connection 414a may therefore be formed from conductive material in the same layer used to form the first conductors 402₉ and 402₁₀. It may therefore be unnecessary to include the insulating material 530, for example if the front aperture layer 420 is formed from an insulating material that separates the layers used to form the first conductors 402₉ and 402₁₀ and the second conductor 404₁₀.

FIG. 5C shows a cross-sectional view along the line A-A′ of a second example display device 500b incorporating a second example implementation of the touch sensor 400 shown in FIGS. 4A and 4B. The device 500b includes many of the features of the display device 500a shown in FIG. 5A. For example, the display device 500b includes a rear substrate 502 coupled to a front substrate 504 by an edge seal 506. Again, in some implementations, a light source 508 and a light guide 510 together form a backlight. A rear aperture plate 512 defines a plurality of apertures, each associated with a respective shutter-based display element 514₁-514₆ (generally referred to as display elements 514). The shutters of display elements 514 are shown in the closed position.

The front aperture layer 420 is positioned on a rear surface of the front substrate 504. The first conductors 402₉ and 402₁₀ are positioned in front of the front aperture layer 420, and the second conductor 404₅ is positioned behind the front aperture layer 420. In some implementations, the second conductor 404₅ can be formed from a light reflecting material, such as aluminum (Al), tantalum (Ta), or molybdenum (Mo). This can help to improve the efficiency of the display. In some implementations, forming the first conductors 402 from a reflective material may decrease the contrast ratio of the display 500b, because ambient light originating outside the display 500b is reflected off of the surface of the display 500b and back toward a viewer, making it more difficult for the display 500b to appear dark even when all of the shutters 514 are in the closed position. Therefore, in some implementations, the first conductors 402 can be formed from a light-absorbing material to prevent a decrease in the contrast ratio of the display. In some implementations, the first conductors 402₉ and 402₁₀ and the second conductor 404₅ can be formed from a single layer of material, as shown in FIG. 5A. In some implementations, this may reduce the thickness of the touch sensor 400, which may reduce the overall thickness of the display 500b. In addition, this may reduce the number of masking steps during fabrication.

FIG. 5D shows a cross-sectional view along the line A-A′ of a third example display device 500c incorporating a third example implementation of the touch sensor 400 shown in FIGS. 4A and 4B. The display device 500c includes many of the features of the display device 500a shown in FIG. 5A. For example, the display device 500c includes a rear substrate 502 coupled to a front substrate 504 by an edge seal 506. A light source 508 and a light guide 510 together form a backlight. A rear aperture layer 512 defines a plurality of apertures 550₁-500₆ (generally referred to as apertures 550), each associated with a respective shutter-based display element 514₁-514₆ (generally referred to as display elements 514). The shutters of display elements 514 are shown in the closed position.

A front aperture layer 420 is positioned on a rear surface of the front substrate 404. The second conductor 404₅ is positioned in front of the front aperture layer 420. In some implementations, the second conductor 404₅ is made from a light-absorbing conductive material, such as a dark metal, in order to help improve the contrast ratio of the display 500c. For example, this can help to reduce the amount of ambient light originating outside the display 500c reflected off of the front surface of the front substrate 504. The first conductors 402₉ and 402₁₀ are positioned behind the front aperture layer 420. In some implementations, the first conductors 402₉ and 402₁₀ can be formed from a light reflecting material, such as Al, TA, or Mo. In some other implementations, the first conductors 402₉ and 402₁₀ can be formed from a light-absorbing material.

The display 500c also includes a conductive shield layer 571 separated from the first conductors 402₉ and 402₁₀ by an electrically insulating layer 560. The shield layer 571 can be formed from a metal or other conductive material to shield the display elements 514 from the touch sensor 400, and vice versa. In some implementations, voltages on the touch sensor 400 can generate an electric field, which can exert a force on the shutter assemblies of the display elements 514. In some implementations, the force may cause the shutters of the display elements 514 to move in an unintended way, for example by opposing the force applied to the shutters by their respective actuators. In addition, the voltage applied to the display elements 514 may interfere with proper touch sensor operation. The conductive shield layer 571 can help mitigate the risk of these potential problems. In some implementations, the shield layer 571 can be continuous except for openings aligned with the apertures 412. In some other implementations, the shield layer 571 can be formed without openings for the apertures 412 if the shield layer 571 is formed from substantially transparent material, such as ITO.

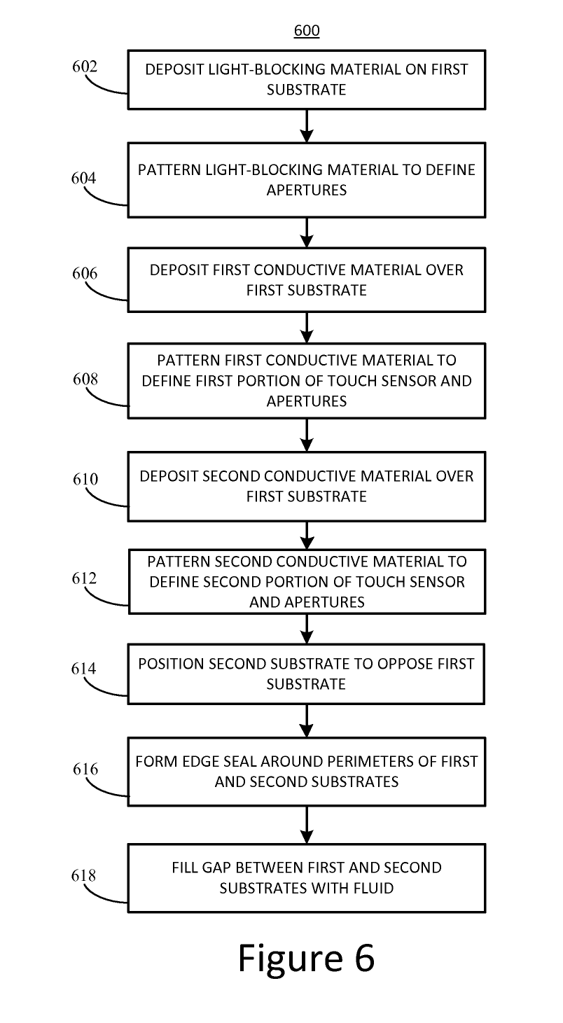

FIG. 6 shows a flow diagram of an example process 600 for manufacturing a display apparatus. For example, the process 600 can be used to manufacture a display incorporating a touch sensor, such as the display 400 shown in FIG. 4A. The process 600 includes depositing a substantially light-blocking material on a rear surface of a first substrate (stage 602). The substantially light-blocking material is patterned to define a plurality of apertures (stage 604). A first layer of conductive material is deposited over the rear surface of the first substrate (stage 606). The first layer of conductive material is patterned to define a first array of conductive elements forming a first portion of a capacitive touch sensor and a plurality of apertures associated with respective apertures formed through the substantially light-blocking material (stage 608). A second layer of conductive material is deposited over the rear surface of the first substrate (stage 610). The second layer of conductive material is patterned to define a second array of conductive elements forming a second portion of a capacitive touch sensor and a plurality of apertures associated with respective apertures formed through the substantially light-blocking material (stage 612). A second substrate is positioned such that the second substrate is substantially parallel to the first substrate and a front surface of the second substrate opposes the rear surface of the first substrate (stage 614). An edge seal is formed around the perimeters of the first and second substrates to couple the first and second substrates to one another (stage 616). A gap between the first and second substrates is filled with a fluid such that the fluid surrounds a plurality of display elements formed on one of the first and second substrates (stage 618).

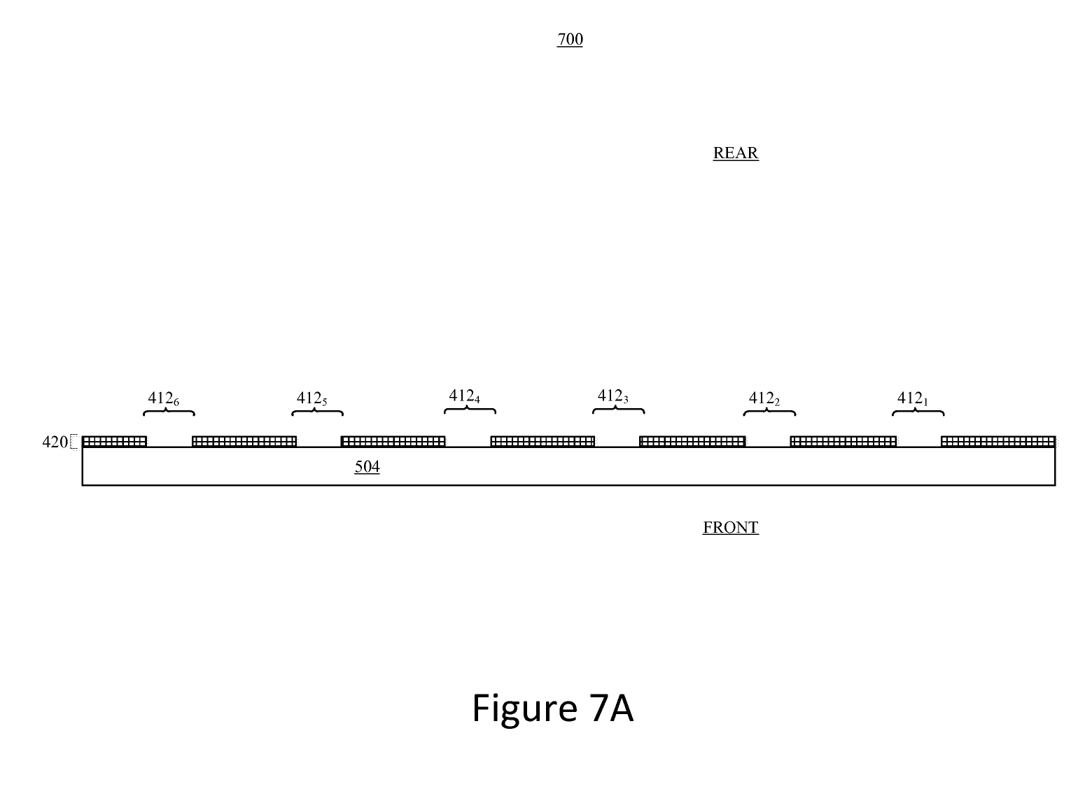

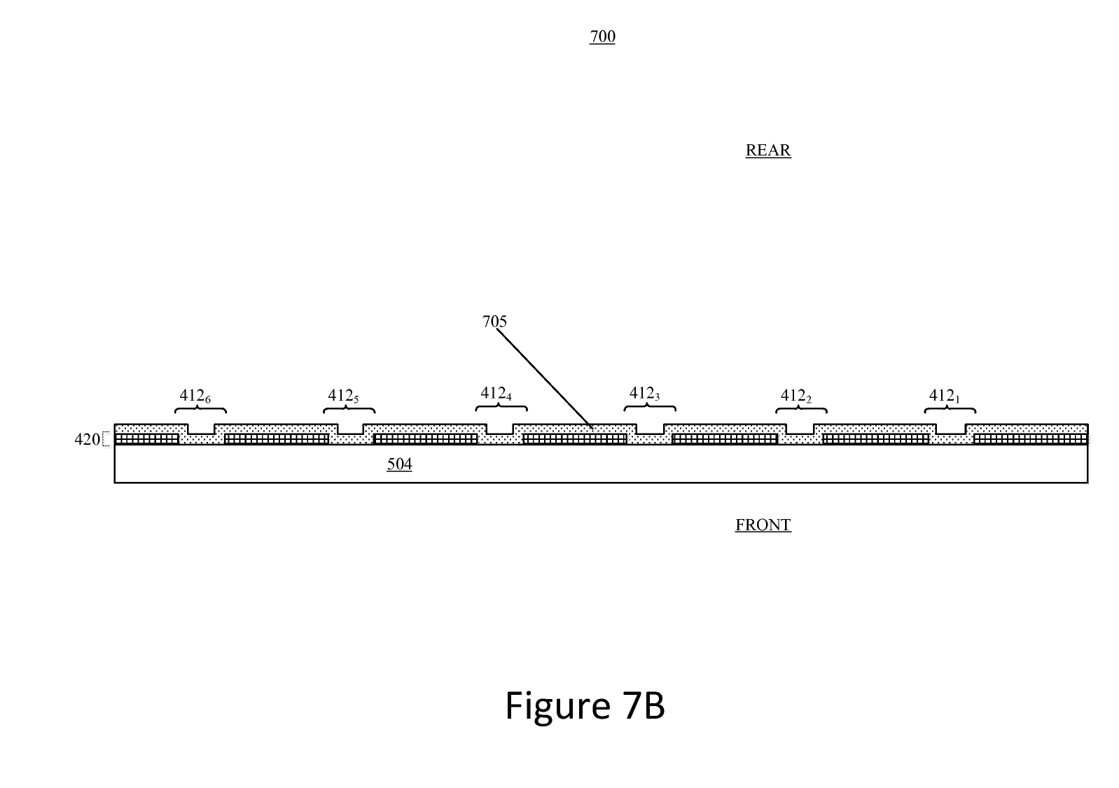

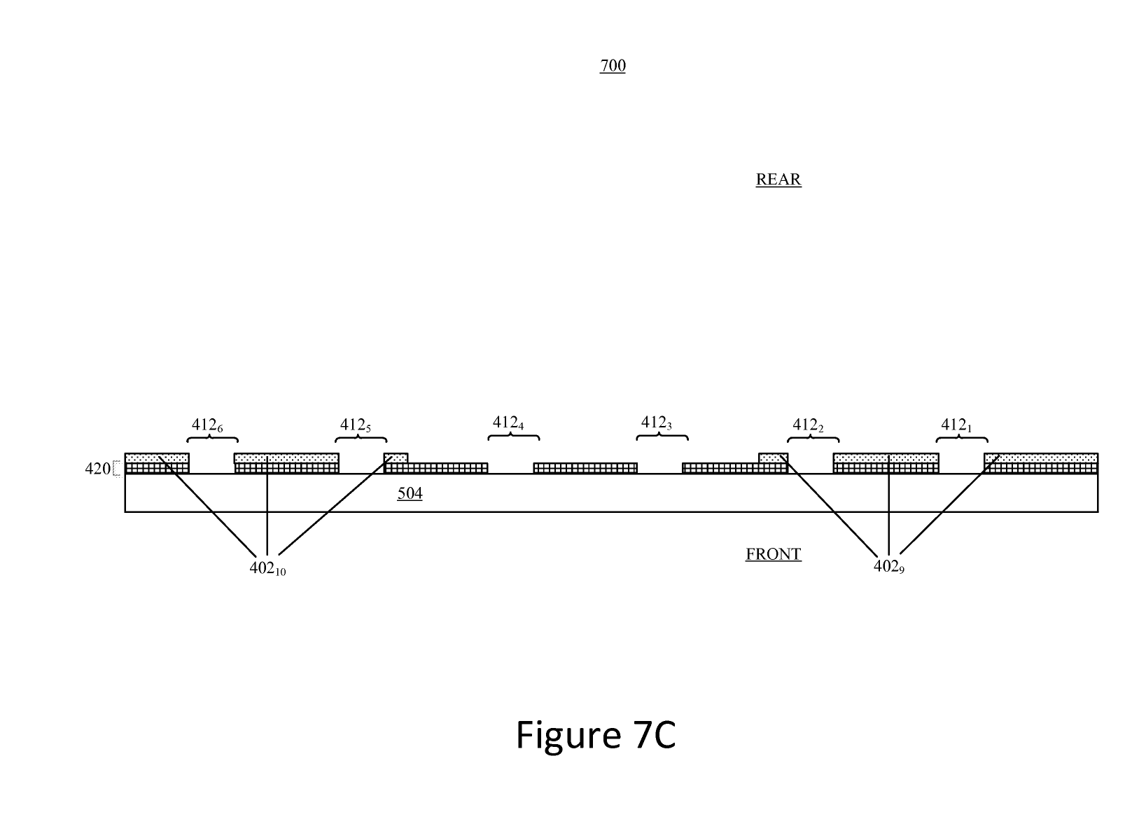

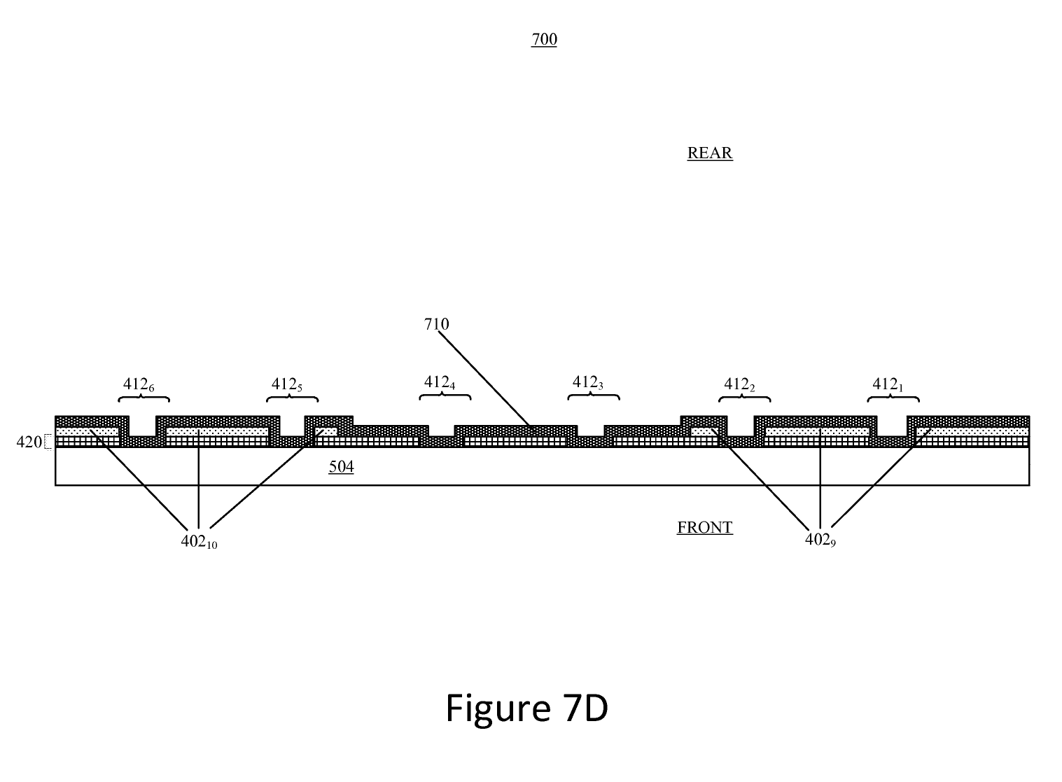

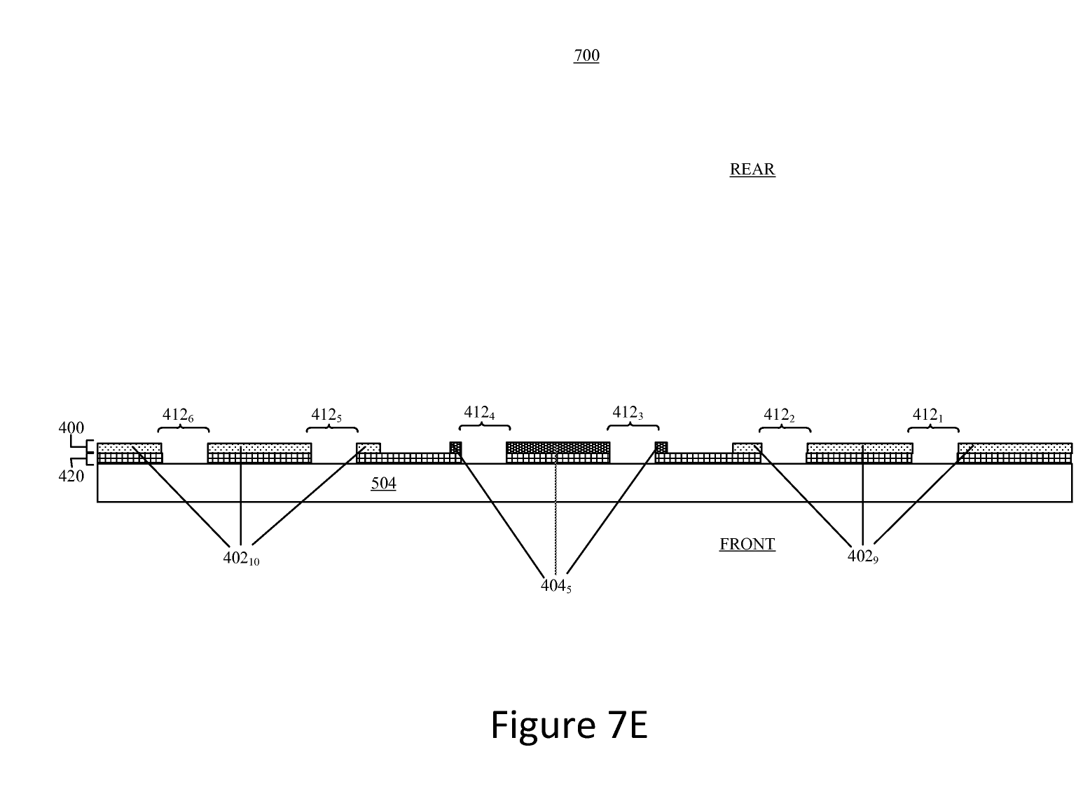

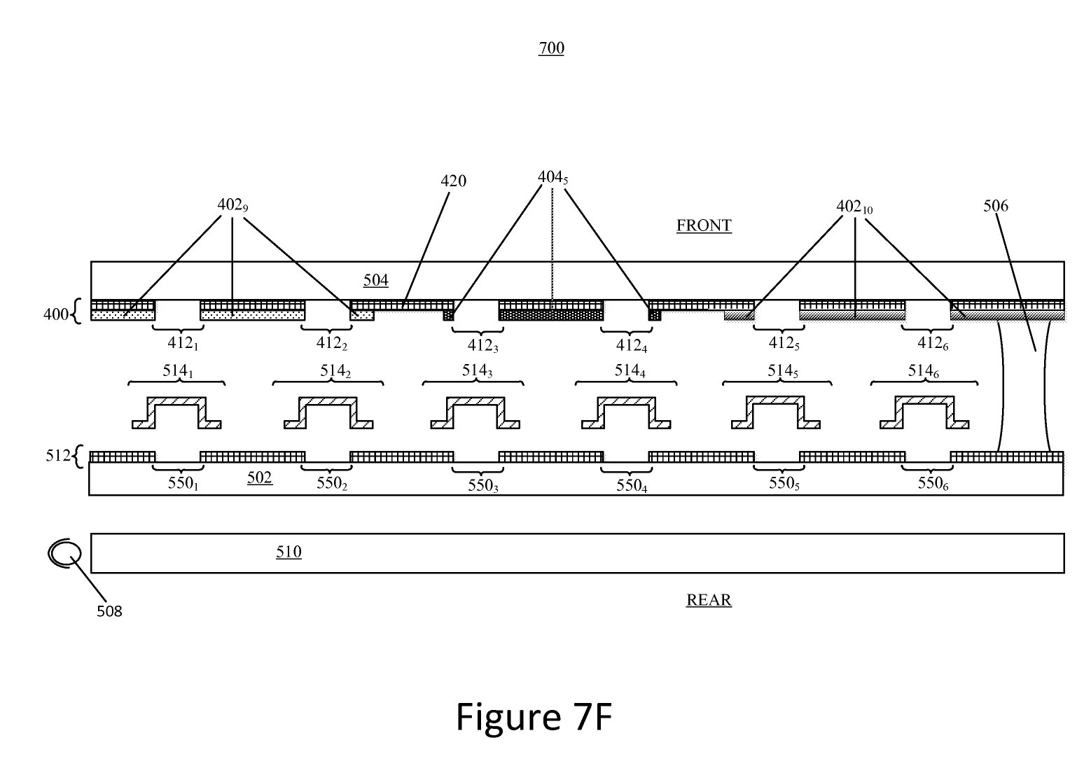

FIGS. 7A-7F show cross-sectional views of stages of construction of an example display according to the manufacturing process 600 shown in FIG. 6. The process 600 is described further below in relation to FIGS. 6 and 7A-7F.

The process 600 begins with depositing a substantially light-blocking material on a rear surface of a first substrate (stage 602) and patterning the substantially light-blocking material to define a plurality of apertures (stage 604). An example of the results of these processing stages is shown in FIG. 7A. In FIG. 7A, a layer of light-blocking material 420 is deposited and patterned over a rear surface of a front substrate 504 to form apertures 412₁-412₆ (generally referred to as apertures 412). The light-blocking material 420 can be or can include molybdenum chromium (MoCr), molybdenum tungsten (MoW), molybdenum titanium (MoTi), molybdenum tantalum (MoTa), titanium tungsten (TiW), or titanium chromide (TiCr). In some implementations, the light-blocking material can be formed from a cermet. In some implementations, the light-blocking material 420 also can be an electrically insulating material, such as black resin matrix. Depending on the material selected for use as the light-blocking material 420, the first layer of light-blocking material 504 can be patterned using a variety of photolithographic techniques and processes such as direct photo-patterning (for photosensitive light-blocking materials) or chemical or plasma etching through a mask formed from a photolithographically patterned resist.

The process 600 includes depositing a first conductive material 705 over the rear surface of the first substrate (stage 606), the results of which are shown in FIG. 7B. In some implementations, the first conductive material 705 can include a layer of light-blocking metal, such as titanium (Ti), aluminum (Al), copper (Cu), nickel (Ni), chromium (Cr), molybdenum (Mo), tantalum (Ta), niobium (Nb), neodymium (Nd), or alloys thereof. In some implementations, the conductive material 705 is deposited to a thickness of less than about 0.5 microns.

The process 600 includes patterning the first conductive material 705 (stage 608) to define a first array of conductive elements 402 forming a first portion of a capacitive touch sensor and a plurality of apertures aligned with respective apertures 412 formed through the substantially light-blocking material 420. FIG. 7C shows an example of the results of this processing stage. In the cross-sectional view of FIG. 7C, only the conductors 402₉ and 402₁₀ formed from the conductive material 705 are shown, though other conductors 402 may be formed as well. In some implementations, a photoresist mask can be deposited on the first conductive material 705 and patterned to serve as an etch mask for the conductive material 705. The etch of the first conductive material 705 can be an anisotropic etch, an isotropic etch, or a combination of anisotropic and isotropic etches.

In some implementations, the process 600 can include depositing a layer of insulating material over the first array of conductive elements 402. The layer of insulating material can then be patterned, for example, to remove insulating material that is not positioned directly over the first conductive elements 402. The insulating material can be used to electrically insulate the first conductors 402 from an array of second conductors 404 formed in a subsequent stage.

The process 600 includes depositing a second layer of conductive material 710 over the rear surface of the first substrate 504 (stage 610). FIG. 7D shows an example of the results of this processing stage. In some implementations, the second conductive material 710 can include a layer of light-blocking metal, such as Ti, Al, Cu, Ni, Cr, Mo, Ta, Nb, Nd, or alloys thereof. In some implementations, the second conductive material 710 is deposited to a thickness of less than about 0.5 microns.

The process 600 includes patterning the second conductive material 710 (stage 612) to define a second array of conductive elements 404 forming a second portion of a capacitive touch sensor and a plurality of apertures aligned with respective apertures 412 formed through the substantially light-blocking material 420, the results of which are shown in FIG. 7E. In some implementations, a photoresist mask can be deposited on the conductive material 710 and patterned such that the remaining conductive material 710 forms the conductor 404₅ having two apertures 412₃ and 412₄. The etch of the conductive material 710 can be an anisotropic etch, an isotropic etch, or a combination of anisotropic and isotropic etches. In some implementations, the formation of the touch sensor 400 may include additional steps such as depositing additional layers to shield the touch sensor from the other electrical components of the display 700.

The process 600 includes positioning a second substrate 502 such that the second substrate 502 is substantially parallel to the first substrate 504 and a front surface of the second substrate 502 opposes the rear surface of the first substrate 504 (stage 614). The process 600 also includes forming an edge seal 506 around the perimeters of the first and second substrates 504 and 502 to couple the first and second substrates 504 and 502 to one another (stage 616), and filling a gap between the first and second substrates 504 and 502 with a fluid such that the fluid substantially surrounds a plurality of display elements formed on one of the first and second substrates 504 and 502 (stage 618). As shown in FIG. 7F, display elements 514₁-514₆ (generally referred to as display elements 514) can be formed on the second substrate 502. For illustrative purposes, only the shutters of the display elements 514 are shown. However, in practice, the display elements 514 can include anchors and other components as described above in connection with FIG. 3. The second substrate 502 also can include an aperture layer 512 having apertures 550₁-550₆ aligned with the apertures 412 formed in the light blocking material 420 on the first substrate 504. In some other implementations, display elements can instead be formed on the first substrate 504. Only a portion of the display 700 is shown in FIG. 7F. If the full display 700 were shown in cross-section, the edge seal 506 also would be visible on the left-hand side of the display 700. The edge seal 506 can trap a fluid, such as an oil, between the first substrate 504 and the second substrate 502. A light source 508 and a light guide 510 can be positioned behind the second substrate 502 to form a backlight. In some implementations, the display 700 can correspond to the display 500a shown in FIG. 5A. The display 700 includes a touch sensor 400 that can be formed from light-blocking materials and positioned within the volume defined by the rear surface of the first substrate 504, the front surface of the second substrate 502, and the edge seal 506.

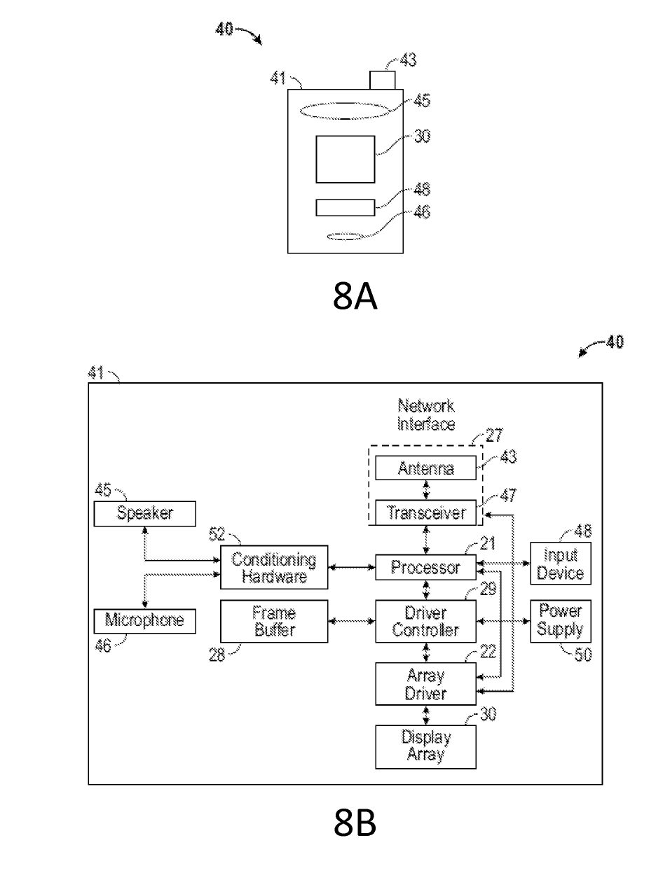

FIGS. 8A and 8B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 8A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
a rear substrate;
a front substrate positioned in front of the rear substrate;
a seal coupling the rear substrate and the front substrate;
a plurality of display elements positioned between the rear substrate and the front substrate;
an aperture layer positioned on a rear surface of the front substrate, the aperture layer comprising a light-blocking material and including a plurality of apertures each associated with a respective display element; and
a capacitive touch sensor including:
a first array of conductive elements positioned between the rear substrate and the rear surface of the front substrate, the first array of conductive elements including a first plurality of apertures defined through the conductive elements and aligned with respective apertures defined through the aperture layer; and
a second array of conductive elements formed between the rear substrate and the rear surface of the front substrate, the second array of conductive elements including a second plurality of apertures defined through the conductive elements and aligned with respective apertures defined through the aperture layer.

2. The apparatus of claim 1, wherein the first and second arrays of conductive elements include light-blocking materials.

3. The apparatus of claim 1, wherein the aperture layer includes an electrically insulating material.

4. The apparatus of claim 1, further comprising a conductive shield layer positioned between the capacitive touch sensor and the plurality of display elements.

5. The apparatus of claim 1, wherein each conductive element of the first and second arrays of conductive elements has a resistance of less than about 100 ohms.

6. The apparatus of claim 1, wherein each conductive element of the first and second arrays of conductive elements has a surface area in the range of about 1 millimeters to about 50 millimeters.

7. The apparatus of claim 1, wherein a distance between each conductive element in the first and second arrays of conductive elements is in the range of about 1 millimeter to about 50 millimeters.

8. The apparatus of claim 1, wherein both the first array of conductive elements and the second array of conductive elements are positioned behind the aperture layer with respect to the front of the apparatus.

9. The apparatus of claim 8, wherein both the first array of conductive elements and the second array of conductive elements include a reflective metal.

10. The apparatus of claim 1, wherein the second array of conductive elements is positioned in front of the aperture layer with respect to the front of the apparatus.

11. The apparatus of claim 10, wherein the second array of conductive elements includes a light-absorbing metal.

12. The apparatus of claim 10, wherein the first array of conductive elements is positioned in front of the aperture layer with respect to the front of the apparatus.

13. The apparatus of claim 10, wherein the first array of conductive elements is positioned behind the aperture layer with respect to the front of the apparatus.

14. The apparatus of claim 1, further comprising:
a display including the apparatus;
a processor capable of communicating with the display, the processor being capable of processing image data; and
a memory device capable of communicating with the processor.

15. The apparatus of claim 14, further comprising:
a driver circuit capable of sending at least one signal to the display; and
a controller capable of sending at least a portion of the image data to the driver circuit.

16. The apparatus of claim 14, further comprising:
an image source module capable of sending the image data to the processor, wherein the image source module includes at least one of a receiver, transceiver, and transmitter.

17. The apparatus of claim 14, further comprising:
an input device capable of receiving input data and communicating the input data to the processor.

18. A method of forming a display device, comprising:
depositing a substantially light-blocking material on a rear surface of a first substrate;
patterning the substantially light-blocking material to define a plurality of apertures;
depositing a first conductive material over the rear surface of the first substrate;
patterning the first layer of conductive material to define a first array of conductive elements forming a first portion of a capacitive touch sensor and a plurality of apertures associated with respective apertures formed through the substantially light-blocking material;
depositing a second conductive material over the rear surface of the first substrate;
patterning the second layer of conductive material to define a second array of conductive elements forming a second portion of the capacitive touch sensor and a plurality of apertures associated with respective apertures formed in the substantially light-blocking material;
positioning a second substrate such that the second substrate is substantially parallel to the first substrate and a front surface of the second substrate opposes the rear surface of the first substrate;
forming an edge seal around the perimeters of the first and second substrates to couple the first and second substrates to one another; and
filling a gap between the first and second substrates with a fluid such that the fluid substantially surrounds a plurality of display elements formed on one of the first and second substrates.

19. The method of claim 18, wherein the first conductive material includes a substantially light-absorbing metal.

20. The method of claim 18, wherein the light-blocking material is deposited between the first conductive material and the second conductive material.

21. The method of claim 20, wherein the second conductive material includes a substantially light-reflecting metal.

22. The method of claim 18, further comprising fabricating the plurality of display elements on the rear surface of the first substrate.

23. The method of claim 18, further comprising fabricating the plurality of display elements on the front surface of the second substrate.

24. The method of claim 18, further comprising:
depositing a layer of insulating material over the first array of conductive elements.

25. An apparatus, comprising:
a rear substrate;
a front substrate positioned in front of the rear substrate;
a seal coupling the rear substrate and the front substrate;
a plurality of display elements positioned between the rear substrate and the front substrate;
a rear aperture layer positioned on a front surface of the rear substrate, the rear aperture layer including a light-blocking material and including a plurality of rear apertures each associated with a respective display element;
a front aperture layer positioned on a rear surface of the front substrate, the front aperture layer including an electrically insulating, light-blocking material and including a plurality of front apertures each associated with a respective display element;
a capacitive touch sensor including:
a first array of conductive elements including a light-blocking material and positioned between the rear substrate and the rear surface of the front substrate, the first array of conductive elements including a first plurality of apertures defined through the conductive elements and aligned with respective apertures defined through the front aperture layer;
a second array of conductive elements including a light-blocking material and positioned between the rear substrate and the rear surface of the front substrate, the second array of conductive elements including a second plurality of apertures defined through the conductive elements and aligned with respective apertures defined through the front aperture layer; and
a controller coupled to the first array of conductive elements and the second array of conductive elements, the controller configured to:
measure, periodically, a capacitance between a first conductive element of the first array of conductive elements and a second conductive element of the array of second conductive elements; and
determine a presence and location of a conductive touch input device, based on the measured capacitance.

26. The apparatus of claim 25, wherein the display elements include MEMS-based display elements.

27. The apparatus of claim 25, wherein at least one of the first array of conductive elements and the second array of conductive elements includes a substantially reflective material and is positioned behind the front aperture layer.

28. The apparatus of claim 25, further comprising a conductive shield layer positioned between the capacitive touch sensor and the plurality of display elements.

29. The apparatus of claim 25, wherein at least one of the first array of conductive elements and the second array of conductive elements includes a substantially light-absorbing material and is positioned in front of the front aperture layer.
